(19) United States
(12) Patent Application Publication
(10) Pub. No.: US 2023/0086961 A1
(43) Pub. Date: Mar. 23, 2023

(54) PARALLAX IMAGE PROCESSING METHOD, APPARATUS, COMPUTER DEVICE AND STORAGE MEDIUM

(71) Applicant: MEGVII (BEIJING) TECHNOLOGY CO., LTD., Beijing (CN)

(72) Inventor: Peng WANG, Beijing (CN)

(21) Appl. No.: 17/800,441

(22) PCT Filed: Sep. 30, 2020
(86) PCT No.: PCT/CN2020/119734

§ 371 Date: Aug. 17, 2022

(30) Foreign Application Priority Data
Mar. 10, 2020 (CN) 202010161147.4

(51) Int. Cl. G06T 5/00; G06T 3/40; G06T 7/136; G06T 7/11; G06T 7/593

(52) U.S. Cl. CPC G06T 5/002; G06T 3/40; G06T 5/005; G06T 7/136; G06T 7/11; G06T 7/593; G06T 2207/30168; G06T 2207/10012

(57) ABSTRACT

The present application relates to a parallax image processing method, an apparatus, a computer device and a storage medium. The method includes: obtaining at least one mask image by performing down-sampling on an initial parallax image, and then performing patch processing and pixel replacement processing on the mask image to obtain a processed mask image, and determining an abnormal parallax value on the initial parallax image according to the processed mask image, and finally performing interpolation processing and filtering processing on the abnormal parallax value on the initial parallax image to obtain a target parallax image.

### CROSS REFERENCE TO RELATED APPLICATIONS

This application claims the priority of Chinese patent application No. 202010161147.4, filed on Mar. 10, 2020 and with title of “parallax image processing method, apparatus, computer device and storage medium”, the entire disclosure of which is incorporated herein by reference as part of the disclosure of this application.

### TECHNICAL FIELD

The present application relates to the technical field of computer vision, in particular to a parallax image processing method, an apparatus, a computer device, and a storage medium.

### BACKGROUND

With the development of computer vision technology, stereo matching technology has become a research hotspot in the field of computer vision, and it has been widely used in binocular ranging, mobile phone dual camera virtualization, and visual robot, etc. However, in practical applications, the parallax image obtained by stereo matching technology usually leads to inaccurate calculation in the matching process due to the influence of factors such as repeated texture or weak texture, complex edge information and so on.

At present, the main method to optimize the parallax image for the above problems is to perform post-processing such as filtering, noise removal, smoothing, etc., so as to improve the quality of the parallax image.

However, the parallax image obtained by the above post-processing method still has the problem of poor quality.

### SUMMARY

Based on this, it is necessary to provide a parallax image processing method, an apparatus, a computer device, and a storage medium that can improve the quality of the parallax image regarding the above technical problems.

According to an aspect of the present application, a parallax image processing method is provided. The method comprises:

obtaining at least one mask image by performing down-sampling on an initial parallax image;

performing patch processing and pixel replacement processing on the mask image to obtain a processed mask image, where the pixel replacement processing comprises replacing a parallax value of each pixel with a parallax value of a similar pixel corresponding to each pixel on the mask image;

determining an abnormal parallax value on the initial parallax image according to the processed mask image; and

performing interpolation processing and filtering processing on the abnormal parallax value on the initial parallax image to obtain a target parallax image.

In one embodiment, performing the patch processing on the mask image comprises:

performing patch detection on the mask image to obtain the abnormal parallax value contained in a patch region on the mask image; and

setting the abnormal parallax value contained in the patch region on the mask image as a first value.

In one embodiment, performing the patch detection on the mask image to obtain the abnormal parallax value contained in the patch region on the mask image comprises:

performing the patch detection on the mask image to obtain the patch region;

determining whether the patch region meets a preset condition; and

in the case where the patch region meets the preset condition, determining the parallax value of each pixel in the patch region as the abnormal parallax value contained in the patch region on the mask image.

In one embodiment, the preset condition comprises a preset amount threshold and a preset mean threshold, and determining whether the patch region meets the preset condition comprises:

determining whether an amount of pixels in the patch region is less than the preset amount threshold, and whether a difference value between a parallax mean value in the patch region and the preset mean threshold is within a preset range;

in the case where the amount of the pixels in the patch region is less than the preset amount threshold, and the difference value between the parallax mean value in the patch region and the preset mean threshold is within the preset range, determining that the patch region meets the preset condition; and

in the case where the amount of the pixels in the patch region is greater than or equal to the preset amount threshold, and/or the difference value between the parallax mean value in the patch region and the preset mean threshold is not within the preset range, determining that the patch region does not meet the preset condition.

In one embodiment, performing the pixel replacement processing on the mask image comprises:

determining the similar pixel corresponding to each pixel on the mask image according to an original image, where a difference value between a pixel value of the similar pixel and a pixel value of a corresponding pixel is a minimum value, and the original image is a gray-scale image corresponding to the initial parallax image; and

correspondingly replacing the parallax value of each pixel with the parallax value of each similar pixel.

In one embodiment, determining the similar pixel corresponding to each pixel on the mask image according to the original image comprises:

finding each original pixel at a corresponding position on the original image according to a position of each pixel on the mask image;

determining a similar original pixel corresponding to each original pixel on the original image, where a difference value between a pixel value of the similar original pixel and a pixel value of a corresponding original pixel is a minimum value; and

according to a position of each similar original pixel, finding each pixel at a corresponding position on the mask image, and determining a found pixel as the similar pixel corresponding to each pixel on the mask image.

In one embodiment, determining the similar original pixel corresponding to each original pixel on the original image comprises:

determining a search range of each original pixel on the original image by taking each original pixel as a center;

calculating pixel differences between the original pixel and other original pixels within the search range; and

determining the original pixel corresponding to a minimum pixel difference as the similar original pixel corresponding to the original pixel on the original image.

In one embodiment, determining the abnormal parallax value on the initial parallax image according to the processed mask image comprises:

adjusting a resolution of the processed mask image to obtain a target mask image, where a resolution of the target mask image is same as a resolution of the initial parallax image; and

mapping a pixel set as the first value on the target mask image to the initial parallax image, and mapping a pixel subjected to parallax value replacement on the target mask image to the initial parallax image, so as to obtain the abnormal parallax value on the initial parallax image.

In one embodiment, in the case where the abnormal parallax value is the first value, performing the interpolation processing on the abnormal parallax value on the initial parallax image comprises:

determining an adjacent region of a pixel corresponding to the abnormal parallax value according to a location of the pixel corresponding to the abnormal parallax value;

searching for a minimum parallax value in the adjacent region; and

replacing the abnormal parallax value with the minimum parallax value.

In one embodiment, the mask image comprises a first mask image and a second mask image, a resolution of the first mask image is higher than a resolution of the second mask image, and performing the patch processing and the pixel replacement processing on the mask image to obtain the processed mask image comprises:

performing the pixel replacement processing on the first mask image to obtain a first processed mask image;

performing the patch processing on the second mask image to obtain a second processed mask image; and

determining the first processed mask image and the second processed mask image as the processed mask image.

In one embodiment, determining the mask image according to the initial parallax image comprises:

performing the down-sampling on the initial parallax image to obtain the first mask image; and

performing the down-sampling on the first mask image to obtain the second mask image.

In one embodiment, performing the down-sampling on the initial parallax image to obtain the first mask image comprises:

performing Gaussian blur on the initial parallax image to obtain a processed parallax image; and

performing the down-sampling on the processed parallax image to obtain the first mask image.

According to another aspect of the present application, a parallax image processing apparatus is provided. The apparatus comprises:

a first determination module, used to obtain at least one mask image by performing down-sampling on an initial parallax image;

a first processing module, used to perform patch processing and pixel replacement processing on the mask image to obtain a processed mask image, where the pixel replacement processing comprises replacing a parallax value of each pixel with a parallax value of a similar pixel corresponding to each pixel on the mask image;

a second determination module, used to determine an abnormal parallax value on the initial parallax image according to the processed mask image; and

a second processing module, used to perform interpolation processing and filtering processing on the abnormal parallax value on the initial parallax image to obtain a target parallax image.

According to still another aspect of the present application, a computer device is provided. The computer device comprises a memory and a processor. The memory stores computer programs, and the processor implements following steps when executing the computer programs:

obtaining at least one mask image by performing down-sampling on an initial parallax image;

performing patch processing and pixel replacement processing on the mask image to obtain a processed mask image, where the pixel replacement processing comprises replacing a parallax value of each pixel with a parallax value of a similar pixel corresponding to each pixel on the mask image;

determining an abnormal parallax value on the initial parallax image according to the processed mask image; and

performing interpolation processing and filtering processing on the abnormal parallax value on the initial parallax image to obtain a target parallax image.

According to still another aspect of the present application, a computer-readable storage medium on which computer programs are stored is provided. The computer programs, when executed by a processor, implement following steps:

obtaining at least one mask image by performing down-sampling on an initial parallax image;

performing patch processing and pixel replacement processing on the mask image to obtain a processed mask image, where the pixel replacement processing comprises replacing a parallax value of each pixel with a parallax value of a similar pixel corresponding to each pixel on the mask image;

determining an abnormal parallax value on the initial parallax image according to the processed mask image; and

performing interpolation processing and filtering processing on the abnormal parallax value on the initial parallax image to obtain a target parallax image.

The parallax image processing method, the apparatus, the computer device and the storage medium described above comprise: obtaining at least one mask image by performing down-sampling on an initial parallax image; and then performing patch processing and pixel replacement processing on the mask image to obtain a processed mask image; determining an abnormal parallax value on the initial parallax image according to the processed mask image; and finally performing interpolation processing and filtering processing on the abnormal parallax value on the initial parallax image to obtain a target parallax image. In the above parallax image processing method, because the mask image is subjected to patch processing and pixel replacement processing, such a processing method can correct wrong parallax value calculated in the initial parallax image due to factors such as repeated textures or weak textures in the original captured image and complex edge information, etc. Therefore, the parallax image processing method provided by the present application can improve the quality of the parallax image. In addition, because the resolution of the mask image obtained by performing down-sampling on the initial parallax image is lower than that of the initial parallax image, and the patch processing and pixel replacement processing are performed on the mask image with low resolution in the later stage, the processing time of the parallax image is greatly reduced, thus improving the processing speed of the parallax image.

### BRIEF DESCRIPTION OF THE DRAWINGS

FIG. 1 is an internal structure diagram of a computer device in an embodiment;

FIG. 2 is a flowchart of a parallax image processing method in an embodiment;

FIG. 3 is a flowchart of step S102 in the embodiment of FIG. 2;

FIG. 4 is a flowchart of step S201 in the embodiment of FIG. 3;

FIG. 5 is a flowchart of step S302 in the embodiment of FIG. 4;

FIG. 6 is a flowchart of step S102 in the embodiment of FIG. 2;

FIG. 7 is a flowchart of step S501 in the embodiment of FIG. 6;

FIG. 8 is a flowchart of step S602 in the embodiment of FIG. 7;

FIG. 9 is a flowchart of step S103 in the embodiment of FIG. 2;

FIG. 10 is a flowchart of step S104 in the embodiment of FIG. 2;

FIG. 11 is a flowchart of step S102 in the embodiment of FIG. 2;

FIG. 12 is a flowchart of step S101 in the embodiment of FIG. 2;

FIG. 13 is a flowchart of step S2001 in the embodiment of FIG. 12;

FIG. 14 is a flowchart of a parallax image processing method in an embodiment; and

FIG. 15 is a structural schematic diagram of a parallax image processing apparatus in an embodiment.

### DETAILED DESCRIPTION

In order to make the purpose, technical scheme and advantages of the present application more clear, the present application is further described in detail below in combination with the accompanying drawings and embodiments. It should be understood that the specific embodiments described herein are only used to explain the present application and are not used to limit the present application.

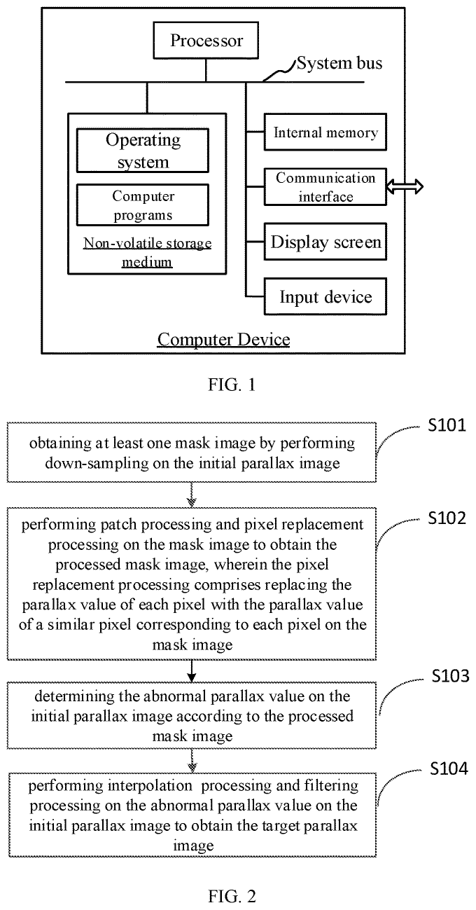

The parallax image processing method provided in the present application can be applied to the computer device shown in FIG. 1, which can be a server or a terminal, and its internal structure diagram can be shown in FIG. 1. The computer device comprises a processor, a memory, a network interface, a display screen and an input device connected through a system bus. The processor of the computer device is used to provide computing and control capabilities. The memory of the computer device comprises a non-volatile storage medium and an internal memory. The non-volatile storage medium stores an operating system and computer programs. The internal memory provides an environment for the operation of the operating system and computer programs in the non-volatile storage medium. The network interface of the computer device is used to communicate with external terminals through network connection. The computer program is executed by a processor to implement a parallax image processing method. The display screen of the computer device can be a liquid crystal display screen or an electronic ink display screen. The input device of the computer device can be a touch layer covered on the display screen, or a key, trackball or touch pad arranged on the computer device shell, or an external keyboard, touch pad or mouse and so on.

Those skilled in the art can understand that the structure shown in FIG. 1 is only a block diagram of a partial structure related to the scheme of the present application, and does not constitute a limitation on the computer device to which the scheme of the present application is applied. The specific computer device may comprises more or less components than those shown in the figure, or combine certain components, or have a different arrangement of components.

In one embodiment, as shown in FIG. 2, a parallax image processing method is provided. The method is applied to the computer device in FIG. 1 as an example, and the method comprises following steps:

S101, obtaining at least one mask image by performing down-sampling on the initial parallax image.

The initial parallax image is an image to be processed, which can be a parallax image obtained by calculating the images obtained by dual-camera shooting by the computer device through the stereo matching algorithm in advance. Alternatively, the initial parallax image can also be obtained by the computer device through other methods, for example, downloading the parallax image directly from the network or obtaining it from the corresponding parallax image database. This embodiment does not limit this. The mask image is an image of the initial parallax image by performing down-sampling at a preset sampling frequency, and may also comprise several images of the initial parallax image by performing down-sampling at different sampling frequencies.

In this embodiment, the computer device can first obtain the initial parallax image, and then perform down-sampling on the initial parallax image with a preset sampling frequency to obtain the parallax image with the corresponding resolution, that is, the mask image. Alternatively, the computer device can also perform down-sampling on the initial parallax image with different sampling frequencies to obtain the parallax images with different resolutions, that is, the mask images with different resolutions. It should be noted that when the mask images with different resolutions are obtained, the resolution of each mask image is less than that of the initial parallax image, and the resolutions of respective mask images can be the same or different. For example, if the resolution of the initial parallax image is 120*120, after performing down-sampling on the initial parallax image with different sampling frequencies, the mask image with a resolution of 60*60 can be obtained, and the mask image with a resolution of 30*30 can also be obtained.

S102, performing patch processing and pixel replacement processing on the mask image to obtain the processed mask image, the pixel replacement processing comprising replacing the parallax value of each pixel with the parallax value of a similar pixel corresponding to each pixel on the mask image.

Patch processing is a processing method for the abnormal parallax value on the mask image, and the abnormal parallax value is usually caused by repeated textures or weak textures in the original captured images in practical applications. Pixel replacement processing is also a processing method for the abnormal parallax value on the mask image, and the abnormal parallax value is usually caused by repeated textures or weak textures in the original captured image and complex edge information in practical applications. In this embodiment, when the computer device obtains a mask image, it can further perform patch processing on the mask image to obtain the image to be processed, and then perform pixel replacement processing on the image to be processed to obtain the processed mask image. Alternatively, the computer device may first perform pixel replacement processing on the mask image to obtain the image to be processed, and then perform patch processing on the image to be processed to obtain the processed mask image. Alternatively, when the computer device obtains a plurality of mask images, it can perform patch processing on the mask image with lower resolution, and perform pixel replacement processing on the mask image with higher resolution, so as to obtain the processed mask image.

S103, determining the abnormal parallax value on the initial parallax image according to the processed mask image.

The abnormal parallax value may be an incorrect parallax value caused by a calculation error when the computer device obtains the initial parallax image by calculating through the stereo matching algorithm. In this embodiment, when the computer device obtains the processed mask image based on the above step S102, the abnormal parallax value on the initial parallax image can be further determined according to the abnormal parallax value on the processed mask image.

S104, performing interpolation processing and filtering processing on the abnormal parallax value on the initial parallax image to obtain the target parallax image.

In this embodiment, when the computer device obtains the abnormal parallax value on the initial parallax image, it can first further perform interpolation processing on the abnormal parallax value to obtain the processed image, and then further perform filtering processing on the processed image to obtain the target parallax image. Alternatively, the computer device can also first perform filtering processing on the abnormal parallax value to obtain the processed image, and then further perform interpolation processing on the processed image to obtain the target parallax image. It should be noted that in practical applications, the above interpolation processing can repair the abnormal parallax values belonging to black holes on the initial parallax image. The above filtering processing may specifically adopt various types of filtering methods, such as median filtering processing. And the above filtering processing can filter outliers and/or noise points on the initial parallax image.

The above embodiments provide a parallax image processing method which comprises: obtaining at least one mask image by performing down-sampling on the initial parallax image, and then performing patch processing and pixel replacement processing on the mask image to obtain the processed mask image, determining the abnormal parallax value on the initial parallax image according to the processed mask image, and finally performing interpolation processing and filtering processing on the abnormal parallax value on the initial parallax image, so as to obtain the target parallax image. In the above parallax image processing method, because patch processing and pixel replacement processing are performed on the mask image, such processing method can correct the parallax value calculated incorrectly in the initial parallax image due to factors such as repeated textures or weak textures in the original captured image and complex edge information in the initial parallax image. Therefore, the parallax image processing method provided in the present application can improve the quality of the parallax image. In addition, because the resolution of the mask image obtained by performing down-sampling on the initial parallax image is lower than that of the initial parallax image, and the patch processing and pixel replacement processing are performed on the mask image with low resolution in the later stage, the processing time of the parallax image is greatly reduced, thus improving the processing speed of the parallax image.

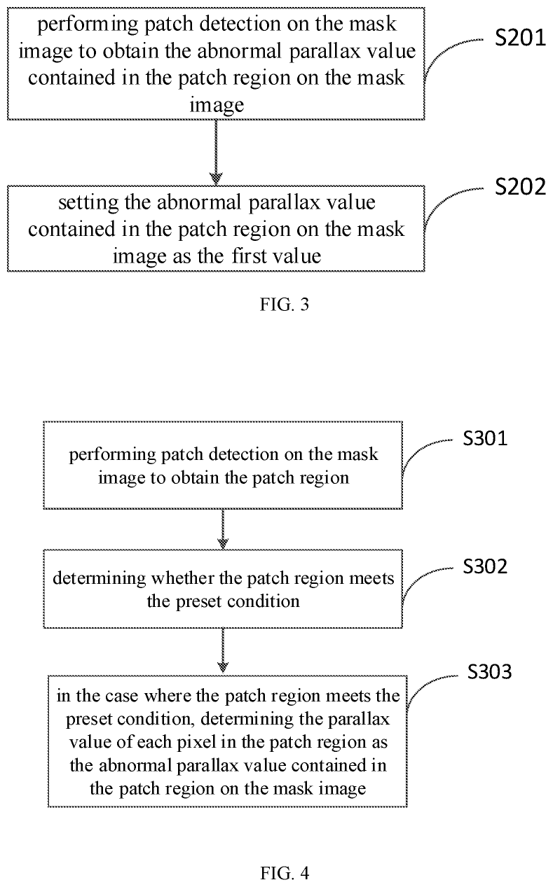

Specifically, the present application also provides a specific embodiment of the above patch processing. As shown in FIG. 3, the “performing patch processing on the mask image” in S102 above comprises:

S201, performing patch detection on the mask image to obtain the abnormal parallax value contained in the patch region on the mask image.

The patch refers to the patch region on the parallax image, and the patch region represents the block aggregation area where the local parallax value and the surrounding parallax value formed on the corresponding parallax image is abnormally distributed due to the parallax error caused by the repeated texture or weak texture in the original image. Therefore, the patch region contains the abnormal parallax value.

This embodiment relates to a method for detecting patches on the mask image, thereby obtaining the abnormal parallax value contained in the patch region on the mask image. The above patch detection method can be a patch detection method in the prior art. For example, a preset patch detection algorithm is used to detect patches on the mask image, and the abnormal parallax value contained in the patch region on the mask image is directly obtained. Alternatively, a preset patch detection network is used to detect the patches on the mask image, and the abnormal parallax value contained in the patch region on the mask image is obtained. The patch detection network can be obtained through pre-training by the computer device according to the corresponding algorithm, and the algorithm can adopt the algorithm of neural network. Alternatively, the above patch detection method can also be designed by the computer device according to the practical application requirements, as long as the abnormal parallax value contained in the patch region on the mask image can be obtained.

S202, setting the abnormal parallax value contained in the patch region on the mask image as the first value.

The first value can be any value, for example, 0, 1, 2, . . . , and so on. The first value can be set in advance by the computer device according to the practical application requirements. In practical applications, the first value is usually set to 0. When the computer device obtains the abnormal parallax value contained in the patch region on the mask image, the computer device can further set all the abnormal parallax values on it as the first value.

The patch processing method provided by the above embodiment can solve the blocking errors in the initial parallax image and correct the wrong parallax values that are not merged with the edges of other objects. Correspondingly, in practical applications, the above blocking error and the wrong parallax values which are not merged with the edges of other objects are usually the parallax values calculated wrong caused by the repeated textures or weak textures in the captured image. Therefore, the method described in the above embodiment can solve the problem of poor quality of parallax image caused by the repeated textures or weak textures in the captured image, and thus the quality of the target parallax image finally obtained is improved.

In one embodiment, the present application also provides a specific embodiment of the above S201. As shown in FIG. 4, “performing patch detection on the mask image to obtain the abnormal parallax value contained in the patch region on the mask image” in the above S201 comprises:

S301, performing patch detection on the mask image to obtain the patch region.

This embodiment relates to a method for detecting patches on the mask image, thereby obtaining the patch region. The above patch detection method can be a patch detection method in the prior art. For example, a preset patch detection algorithm is used to detect the patches on the mask image to obtain all the patch regions on the mask image. Alternatively, a preset patch detection network is used to segment the patch region on the mask image so as to obtain all the patch regions on the mask image. In practical applications, the above patch region can be one or more.

S302, determining whether the patch region meets the preset condition.

The preset condition is a condition determined by the computer device in advance according to the practical application requirements, which is used to measure whether there is an abnormal parallax value in the patch region. When the computer device detects and obtains all the patch regions on the mask image, it can further determine whether each patch region meets the preset condition, so that when the patch region meets the preset condition, the computer device can further process the patch region.

S303, in the case where the patch region meets the preset condition, determining the parallax value of each pixel in the patch region as the abnormal parallax value contained in the patch region on the mask image.

This embodiment relates to an application scenario in which the patch region meets the preset condition. In this application scenario, the computer device can determine the patch region that meets the preset condition as an abnormal patch region, and determine the parallax value of each pixel in the abnormal patch region as the abnormal parallax value contained in the patch region on the mask image.

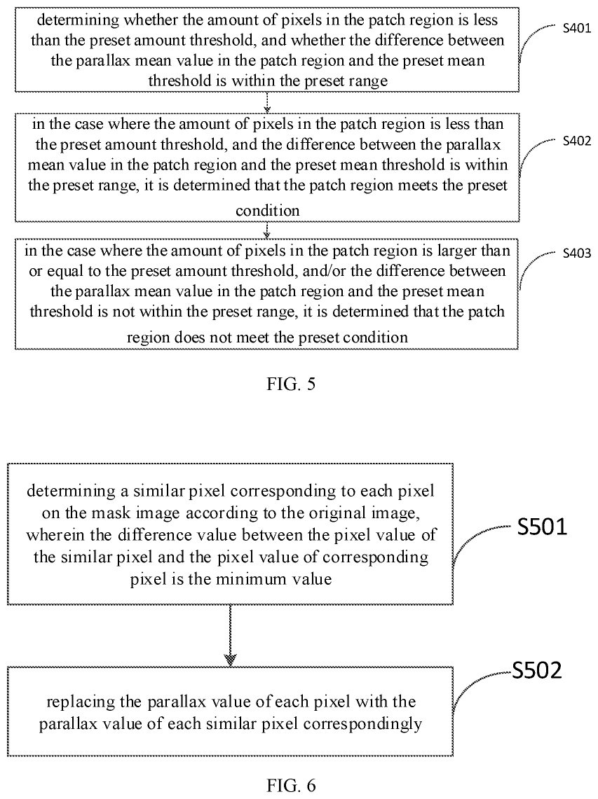

Specifically, the present application provides a preset condition, and the preset condition comprises a preset amount threshold and a preset mean threshold. Accordingly, “determining whether the patch region meets the preset condition” in S302 above, as shown in FIG. 5, comprises:

S401, determining whether the amount of pixels in the patch region is less than the preset amount threshold, and whether the difference value between the parallax mean value in the patch region and the preset mean threshold is within the preset range.

The preset amount threshold, the preset mean threshold, and the preset range can be determined in advance by the computer device according to the practical application requirements. In this embodiment, when the computer device determines whether the patch region meets the preset condition, it can first count the amount of all pixels in the patch region, and then determine whether the amount is less than the preset amount threshold. If the amount is less than the preset amount threshold, it can further calculate the parallax mean value of parallax values of all the pixels in the patch region, and then calculate the difference value between the calculated parallax mean value and the preset mean threshold, obtain the difference value between the parallax mean value in the patch region and the preset mean threshold, and further determine whether the difference value is within the preset range. Alternatively, the computer device can also first calculate the parallax mean value of the parallax values of all the pixels in the patch region, and then calculate the difference value between the calculated parallax mean value and the preset mean threshold to obtain the difference value between the parallax mean value in the patch region and the preset mean threshold, and determine whether the difference value is within the preset range. If the above difference value is within the preset range, the amount of all pixels in the patch region can be further counted, and whether the amount is less than the preset amount threshold can be determined. The determination result can be obtained through the above two times of determination. In particular, the difference value between the parallax mean value in the above patch region and the preset mean threshold is positive value.

S402, in the case where the amount of pixels in the patch region is less than the preset amount threshold, and the difference value between the parallax mean value in the patch region and the preset mean threshold is within the preset range, it is determined that the patch region meets the preset condition.

This embodiment relates to how to determine that the patch region meets the preset condition. In this application environment, if the amount of pixels in the patch region is less than the preset amount threshold, and the difference value between the parallax mean value in the patch region and the preset mean threshold is within the preset range, it can be determined that the patch region meets the preset condition.

S403, in the case where the amount of pixels in the patch region is larger than or equal to the preset amount threshold, and/or the difference value between the parallax mean value in the patch region and the preset mean threshold is not within the preset range, it is determined that the patch region does not meet the preset condition.

This embodiment relates to how to determine that the patch region does not meet the preset condition. In this application environment, if the amount of pixels in the patch region is larger than or equal to the preset amount threshold, and/or the difference value between the parallax mean value in the patch region and the preset mean threshold is not within the preset range, it can be determined that the patch region does not meet the preset condition.

In one embodiment, the present application also provides a specific embodiment of the above pixel replacement processing. As shown in FIG. 6, “performing pixel replacement processing on the mask image” in S102 above comprises:

S501, determining a similar pixel corresponding to each pixel on the mask image according to the original image, the difference value between the pixel value of the similar pixel and the pixel value of the corresponding pixel is the minimum value.

The original image is the gray-scale image corresponding to the initial parallax image. This embodiment relates to a method for a computer device to perform pixel replacement processing on a mask image. Specifically, the computer device can calculate and obtain the similar pixel corresponding to each pixel on the mask image by using the location information of the pixel on the original image, so that the parallax value of each pixel on the mask image can be corrected by using the similar pixel corresponding to each pixel on the mask image later.

S502, correspondingly replacing the parallax value of each pixel with the parallax value of each similar pixel.

When the computer device obtains the similar pixel corresponding to each pixel on the mask image, it can further replace the parallax value of each corresponding pixel with the parallax value of each similar pixel, so as to achieve the purpose of correcting the parallax value of each pixel. It should be noted that, in the specific operation, the computer device can traverse all the pixels on the mask image, and then perform the replacement processing of the above process on each pixel.

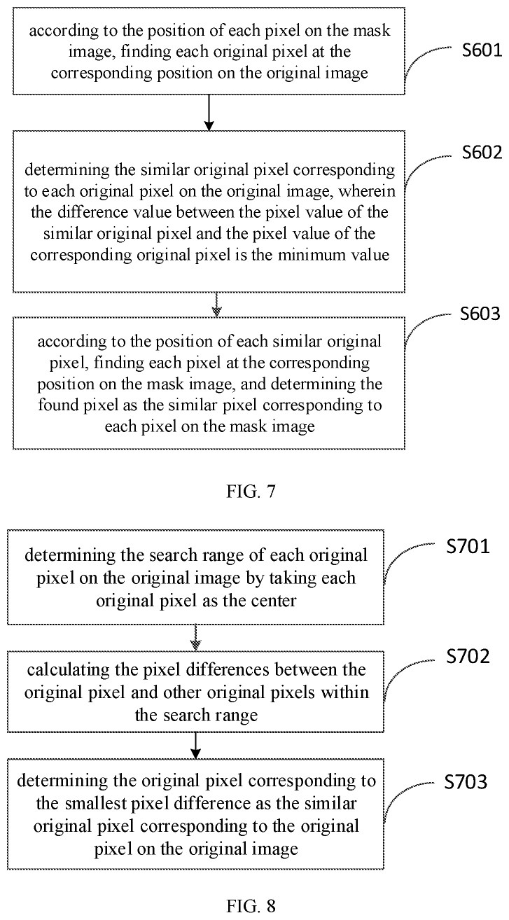

Alternatively, the specific embodiment of “determining the similar pixel corresponding to each pixel on the mask image according to the original image” in S501 described above, as shown in FIG. 7, comprises:

S601, according to the position of each pixel on the mask image, finding each original pixel at the corresponding position on the original image.

When the computer device determines the similar pixel corresponding to each pixel on the mask image according to the original image, it can find each original pixel on the original image at the corresponding position according to the location of each pixel on the mask image, so as to determine the similar pixel corresponding to each pixel on the mask image by using these original pixels.

S602, determining the similar original pixel corresponding to each original pixel on the original image, the difference value between the pixel value of the similar original pixel and the pixel value of the corresponding original pixel being the minimum value.

This embodiment relates to a method for a computer device to determine the similar original pixel corresponding to each original pixel on the original image. Specifically, the computer device can search the original pixel with the smallest difference from the pixel value of the original pixel on the original image, and then determine the original pixel with the smallest difference as a similar original pixel corresponding to the above original pixel.

S603, according to the position of each similar original pixel, finding each pixel at the corresponding position on the mask image, and determining the found pixel as the similar pixel corresponding to each pixel on the mask image.

In this embodiment, when the computer device obtains a similar original pixel corresponding to the original pixel based on the above steps, it can further find the pixel at the corresponding position on the mask image according to the position of the similar original pixel on the original image, and determine the pixel as the similar pixel corresponding to the pixel on the mask image.

Alternatively, as shown in FIG. 8, the specific embodiment of “determining the similar original pixel corresponding to each original pixel on the original image” in the above S602 comprises:

S701, determining the search range of each original pixel on the original image by taking each original pixel as the center.

When the computer device finds each original pixel at the corresponding position on the original image, it can first determine the search range of each original pixel on the original image by take each original pixel as the center. For example, a rectangular area or a circular area with the original pixel p as the center and r as the radius (r can be determined by the computer device according to the practical application requirements) can be the search range.

S702, calculating the pixel differences between the original pixel and other original pixels within the search range.

Taking one original pixel as an example, when the search range of the original pixel is determined, the computer device can calculate the difference between the pixel value of the original pixel and the pixel values of other original pixels on the original image within the search range, so as to obtain the pixel differences between the original pixel and other original pixels.

S703, determining the original pixel corresponding to the smallest pixel difference as the similar original pixel corresponding to the original pixel on the original image.

In this embodiment, when the computer device obtains the pixel differences between the original pixel and other original pixels within the search range based on the above steps, it can further determine the minimum pixel difference from the obtained several pixel differences, and directly determine the original pixel corresponding to the minimum pixel difference as the similar original pixel corresponding to the original pixel on the original image.

In the pixel replacement processing method provided in the above embodiments of FIG. 6 to FIG. 8, because the parallax value of the similar original pixel corresponding to the original pixel on the original image is accurate relative to the parallax value of each pixel on the mask image, the parallax value of the corresponding pixel is replaced by the parallax value of the similar pixel corresponding to each pixel on the mask image, which can achieve the purpose of correcting the parallax value of each pixel on the mask image, therefore, the accuracy of the parallax value of each pixel on the mask image after the pixel replacement process can be improved.

In addition, the pixel replacement processing method provided in the above embodiments of FIG. 6 to FIG. 8 can solve the blocking error in the initial parallax image and the wrong parallax value caused by the region which is merged with the edges of other objects and is highly similar in the parallax value. Correspondingly, in practical applications, the above blocking error and the wrong parallax value caused by the region that is merged with the edges of other objects and is highly similar in the parallax value are usually the parallax value of the calculation error caused by the repeated textures or weak textures in the captured image and the complex edge information. Therefore, the method described in the above embodiments can solve the problem of the poor quality of parallax image caused by the repeated textures or weak textures in the captured image and the complex edge information, which improves the quality of the target parallax image finally obtained.

In one embodiment, as shown in FIG. 9, the specific embodiment of “determining the abnormal parallax value on the initial parallax image according to the processed mask image” in above S103 comprises:

S801, adjusting the resolution of the processed mask image to obtain the target mask image, the resolution of the target mask image being the same as that of the initial parallax image.

When the computer device performs patch processing and pixel replacement processing on the mask image to obtain the processed mask image, it can further adjust the resolution of the processed mask image to obtain the target mask image, so that the resolution of the target mask image is the same as the resolution of the initial parallax image. For example, if the resolution of the initial parallax image is 120*120 and the resolution of the processed mask image is 60*60, the resolution of the target mask image obtained by adjusting the resolution of the processed mask image is 120*120. As for the specific adjustment method, any existing resolution improvement method, such as interpolation processing method, can be adopted, which is not limited in this embodiment.

S802, mapping the pixel set as the first value on the target mask image to the initial parallax image, and mapping the pixel subjected to parallax value replacement on the target mask image to the initial parallax image, so as to obtain the abnormal parallax value on the initial parallax image.

When the computer device obtains the target mask image, it can first find the pixel set as the first value on the target mask image, then map the pixel set as the first value to the initial parallax image according to the location of the pixel set as the first value, then find the pixel subjected to parallax value replacement on the target mask image, and then map the pixel subjected to parallax value replacement to the initial parallax image according to the location of the pixel subjected to parallax value replacement. Alternatively, the computer device can first find the pixel subjected to parallax value replacement on the target mask image, then map the pixel subjected to parallax value replacement to the initial parallax image according to the location of the pixel subjected to parallax value replacement, then find the pixel set as the first value on the target mask image, and then map the pixel set to the first value to the initial parallax image according to the location of the pixel set as the first value. The pixel set as the first value and mapped to the initial parallax image and the pixel subjected to parallax value replacement are determined as abnormal parallax values on the initial parallax image.

The method for determining the abnormal parallax values on the initial parallax image provided by the above embodiments is determined by the pixel set as the first value on the target mask image and the pixel subjected to parallax value replacement. Because the resolution of the mask image is less than the resolution of the initial parallax image, when calculating the pixel set as the first value on the mask image and the pixel subjected to parallax value replacement according to the processed mask image in the early stage, a certain calculation time can be reduced. In the later stage, the process that mapping the pixel set as the first value on the target mask image and the pixel subjected to parallax value replacement to the initial parallax image to determine the abnormal parallax values on the initial parallax image does not require a lot of time. Therefore, in the entire process of determining the abnormal parallax values on the initial parallax image, compared with the traditional method of directly processing the initial parallax image to obtain the abnormal parallax values, the method proposed in this embodiment greatly reduces the calculation time and improves the calculation speed.

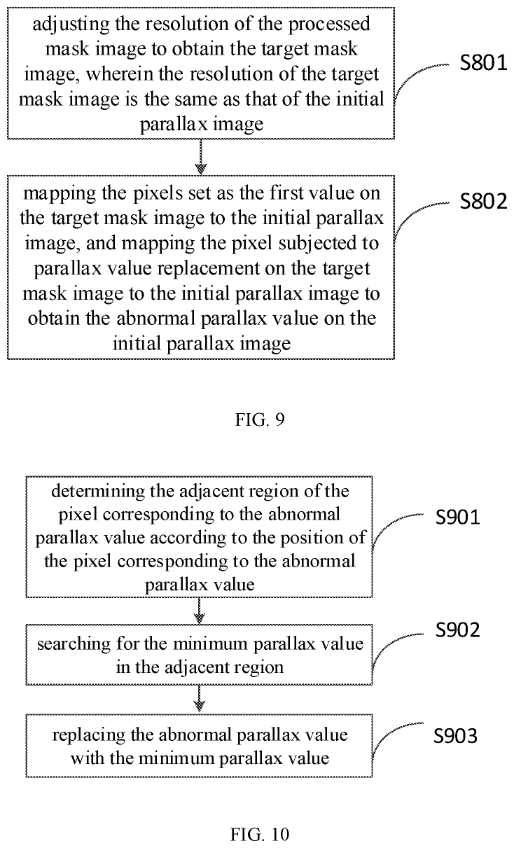

In practical applications, the specific embodiment of “performing interpolation processing on the abnormal parallax value on the initial parallax image” in step S104 of the above implementation, as shown in FIG. 10, comprises:

S901, determining the adjacent region of the pixel corresponding to the abnormal parallax value according to the position of the pixel corresponding to the abnormal parallax value.

When the computer device determines the abnormal parallax value on the initial parallax image, it can further use the linear scanning method for domain interpolation. That is, taking one abnormal parallax value as an example for illustration, and the abnormal parallax value being the first value, the computer device first determines the adjacent region of the pixel corresponding to the abnormal interpolation according to the location of the pixel corresponding to the abnormal parallax value, then find the pixels that can be used for interpolation according to the adjacent region to complete the interpolation operation. Because it is a linear scanning method, the location of the adjacent region is on the same row of the location of the pixel corresponding to the abnormal parallax value. For example, the adjacent region is determined according to the pixel corresponding to one abnormal parallax value in the first row of the initial parallax image, the adjacent region is the left region and/or the right region on the same row as the pixel.

S902, searching for the minimum parallax value in the adjacent region.

When the computer device determines the adjacent region of the pixel corresponding to one abnormal parallax value, it can further search in the adjacent region, specifically searching for the smallest parallax value.

S903, replacing the abnormal parallax value with the minimum parallax value.

When the computer device searches for the minimum parallax value in the adjacent region of the pixel corresponding to the abnormal parallax value, it can replace the abnormal parallax value with the minimum parallax value. For example, the abnormal parallax value is the first value, the minimum parallax value searched in the adjacent region of the first value is the second value, and the corresponding abnormal parallax value of the first value is reset to the second value, that is, the replacement process of the parallax value is completed. It should be noted that the above is only an example of one abnormal parallax value. During the specific operation, the computer device can perform linear scanning on the initial parallax image to realize the replacement processing of the above process for abnormal parallax values on respective rows.

The method for performing interpolation processing on the abnormal parallax value on the initial parallax image provided by the above embodiment, especially when the abnormal parallax value is the first value, indicates that a lot of holes may be generated on the initial parallax image, so the method provided by the above embodiment fills the holes by performing interpolation processing with the minimum parallax value, thus improving the quality of the processed parallax image.

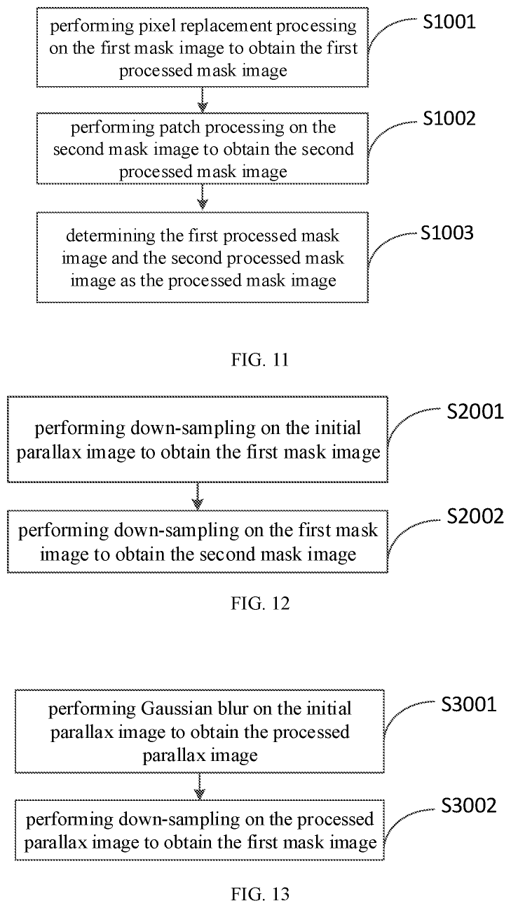

In one embodiment, when the mask image obtained by step S101 of the embodiment in FIG. 2 is two mask images, that is, the first mask image and the second mask image, and the resolution of the first mask image is higher than that of the second mask image, at this time, “performing patch processing and pixel replacement processing on the mask image to obtain the processed mask image” in step S102 of the above embodiment in FIG. 2, as shown in FIG. 11, comprises:

S1001, performing pixel replacement processing on the first mask image to obtain the first processed mask image.

This embodiment relates to a computer device performing pixel replacement processing on the first mask image with a higher resolution to obtain the first processed mask image, so as to use the first processed mask image later to determine that the abnormality on the initial parallax image is a difference value. For the specific method of pixel replacement processing, reference may be made to the descriptions of the foregoing embodiments, and redundant descriptions are not repeated here.

S1002, performing patch processing on the second mask image to obtain the second processed mask image.

The present embodiment relates to a computer device performing patch processing on the second mask image with a lower resolution to obtain the second processed mask image, so as to use the second processed mask image to determine that the abnormality on the initial parallax image is a difference value. For the specific method of patch processing, reference may be made to the descriptions of the above embodiments, and redundant descriptions are not repeated here.

S1003, determining the first processed mask image and the second processed mask image as the processed mask images.

When the computer device obtains the first processed mask image and the second processed mask image based on the above steps, the processed mask images can be obtained.

The method provided by the above embodiments is to perform different processing on mask images with different resolutions, that is, to perform pixel replacement processing on the first mask image with a higher resolution and perform patch processing on the first mask image with a lower resolution. The above processing method makes each processing process unaffected, further improves the accuracy of the processed image, and thus improves the quality of the processed parallax image.

Alternatively, the present application also provides a specific embodiment of above S101. As shown in FIG. 12, “determining the mask image according to the initial parallax image” in the above S101 comprises:

S2001, performing down-sampling on the initial parallax image to obtain the first mask image.

When the computer device determines the mask image according to the initial parallax image, especially the first mask image, specifically, it can perform down-sampling on the initial parallax image to obtain the first mask image, so that the resolution of the first mask image is lower than that of the initial parallax image. It should be noted that the down-sampling frequency during the down-sampling processing can be determined by the computer device in advance according to practical applications, as long as the resolution of the first mask image after down-sampling is lower than the resolution of the initial parallax image. For example, the computer device may perform a 0.5-ratio length-width scaling sampling on the initial parallax image.

S2002, performing down-sampling on the first mask image to obtain the second mask image.

When the computer device determines the mask image according to the initial parallax image, especially the second mask image, specifically, it can perform down-sampling on the initial parallax image to obtain the first mask image, so that the resolution of the first mask image is lower than that of the initial parallax image, and then perform the same down-sampling processing on the first mask image to obtain the second mask image, so that the resolution of the second mask image is lower than that of the first mask image. It should be noted that the down-sampling frequency during the down-sampling processing in the above process may be the same as that during the down-sampling processing in above S2001, or may be different from that during the down-sampling processing in above S2001. For example, if the ratio of the length-width scaling sampling is 0.5 during the down-sampling processing in above S2001, the corresponding ratio of the length-width scaling sampling during the down-sampling processing in this embodiment is also 0.5. Alternatively, the computer device can also perform down-sampling on the initial parallax image to directly obtain the second mask image, so that the resolution of the second mask image is lower than that of the initial parallax image, and at the same time, the resolution of the second mask image is lower than that of the first mask image.

Specifically, as shown in FIG. 13, the specific embodiment of “performing down-sampling on the initial parallax image to obtain the first mask image” in above S2001 comprises:

S3001, performing Gaussian blur on the initial parallax image to obtain the processed parallax image.

In practical applications, there is also an application scenario. Before the computer device determines the mask image according to the initial parallax image, it can first perform Gaussian blur on the initial parallax image to smooth the initial parallax image. Specifically, the computer device can perform Gaussian blur on the initial parallax image with a preset radius, and the preset radius can be determined by the computer device in advance according to the practical application requirements. For example, the computer device can perform Gaussian blur with a radius of 3*3 on the initial parallax image.

S3002, performing down-sampling on the processed parallax image to obtain the first mask image.

After the computer device performs Gaussian blur on the initial parallax image and obtains the processed parallax image, then, the computer device can perform down-sampling on the processed parallax image according to the method of down-sampling described in foregoing S1001, so as to obtain the first mask image, so that the resolution of the first mask image is lower than that of the processed parallax image.

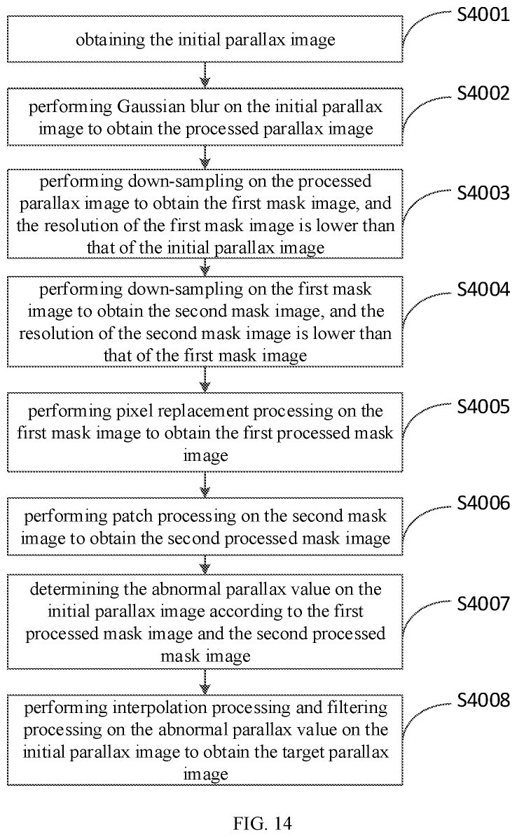

Based on all the above embodiments, the present application also provides a specific processing method for parallax image. As shown in FIG. 14, the method comprises:

S4001, obtaining the initial parallax image;

S4002, performing Gaussian blur on the initial parallax image to obtain the processed parallax image;

S4003, performing down-sampling on the processed parallax image to obtain the first mask image, and the resolution of the first mask image being lower than that of the initial parallax image;

S4004, performing down-sampling on the first mask image to obtain the second mask image, and the resolution of the second mask image being lower than that of the first mask image;

S4005, performing pixel replacement processing on the first mask image to obtain the first processed mask image;

S4006, performing patch processing on the second mask image to obtain the second processed mask image;

S4007, determining the abnormal parallax values on the initial parallax image according to the first processed mask image and the second processed mask image;

S4008, performing interpolation processing and filtering processing on the abnormal parallax values on the initial parallax image to obtain the target parallax image.

The contents described in each step of the above embodiment are basically the same as those described in the foregoing embodiments. For the detailed content of the steps, reference may be made to the foregoing descriptions, and the redundant descriptions are not repeated here. In the parallax image processing method provided by the present application, the first mask image and the second mask image with different resolutions are determined according to the initial parallax image in the processing process, and both the resolution of the first mask image and the resolution of the second mask image are lower than that of the initial parallax image, and the resolution of the second mask image is lower than that of the first mask image. Such a method is equivalent to constructing a three-layer multi-scale pyramid-like image structure based on the initial parallax image, and then different image processing is performed on the first layer (i.e., the second mask image) and the second layer (i.e., the first mask image) of the multi-scale pyramid, respectively. In addition to saving processing time, the processing processes of respective layers are not affected by each other, thus improving the quality of the processed parallax image.

It should be understood that although the steps in the flowcharts of FIG. 2 to FIG. 14 are shown in sequence according to the arrows, these steps are not necessarily performed in sequence according to the order of arrows. Unless explicitly stated in this document, there is no strict sequence restriction for the execution of these steps, and these steps can be executed in other sequences. Moreover, at least part of the steps in FIG. 2 to FIG. 14 may comprise multiple steps or multiple phases. These steps or phases are not necessarily executed at the same time, but can be executed at different times. The execution sequence of these steps or phases is not necessarily sequential, but may be executed in turn or alternatively with other steps or at least part of the steps or phases in other steps.

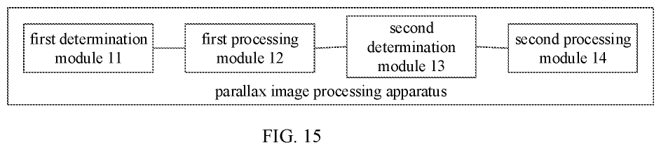

In one embodiment, as shown in FIG. 15, a parallax image processing apparatus is provided, and the apparatus comprises:

a first determination module 11, used to perform down-sampling on the initial parallax image to obtain at least one mask image;

a first processing module 12, used to perform patch processing and pixel replacement processing on the mask image to obtain the processed mask image, where the pixel replacement processing comprises replacing the parallax value of each pixel with the parallax value of a similar pixel corresponding to each pixel on the mask image;

a second determination module 13, used to determine the abnormal parallax value on the initial parallax image according to the processed mask image;

a second processing module 14, used to perform interpolation processing and filtering processing on the abnormal parallax value on the initial parallax image to obtain the target parallax image.

For the specific definition of the parallax image processing apparatus, reference may be made to the above definition of the parallax image processing method, which will not be repeated here. Each module in the above parallax image processing apparatus may be implemented in whole or in part by software, hardware, and combinations thereof The above modules may be embedded in or independent of the processor in the computer device in the form of hardware, or stored in the memory in the computer device in the form of software, so that the processor can call and execute the corresponding operations of the above modules.

In one embodiment, a computer device is provided, which comprises a memory and a processor. Computer programs are stored in the memory, and the processor implements the following steps when executing the computer programs:

obtaining at least one mask image by performing down-sampling on the initial parallax image;

performing patch processing and pixel replacement processing on the mask image to obtain the processed mask image, where the pixel replacement processing comprises replacing the parallax value of each pixel with the parallax value of a similar pixel corresponding to each pixel on the mask image;

determining the abnormal parallax value on the initial parallax image according to the processed mask image; and

performing interpolation processing and filtering processing on the abnormal parallax values on the initial parallax image to obtain the target parallax image.

In one embodiment, a computer-readable storage medium on which computer programs are stored is provided. When executed by a processor, the computer programs implement the following steps:

obtaining at least one mask image by performing down-sampling on the initial parallax image;

performing patch processing and pixel replacement processing on the mask image to obtain the processed mask image, where the pixel replacement processing comprises replacing the parallax value of each pixel with the parallax value of a similar pixel corresponding to each pixel on the mask image;

determining the abnormal parallax values on the initial parallax image according to the processed mask image; and

performing interpolation processing and filtering processing on the abnormal parallax values on the initial parallax image to obtain the target parallax image.

Those of ordinary skill in the art can understand that all or part of the processes in the methods of the above embodiments can be implemented by instructing relevant hardware through computer programs. The computer programs may be stored in a non-volatile computer-readable storage medium. When the computer program is executed, it can comprise the processes of the embodiments of the above method. Any reference to memory, storage, database or other media used in the embodiments provided by the present application may comprise at least one of non-volatile memory and volatile memory. Non-volatile memory may comprise read-only memory (ROM), magnetic tape, floppy disk, flash memory, optical memory and so on. Volatile memory may comprise random access memory (RAM) or external cache memory. As an illustration rather than a limitation, RAM may be in various forms, such as static random access memory (SRAM) or dynamic random access memory (DRAM) and so on.

The technical features of the above embodiments can be combined arbitrarily. In order to simplify the description, all possible combinations of the technical features in the above embodiments are not described. However, as long as there is no contradiction in the combination of these technical features, it should be considered as the scope of the description.

The above-mentioned embodiments only express several embodiments of the present application, and the descriptions thereof are more specific and detailed, but should not be understood as a limitation on the scope of the invention patent. It should be pointed out that for those of ordinary skill in the art, several modifications and improvements can be made without departing from the concept of the present application, which all belong to the protection scope of the present application. Therefore, the protection scope of the present application shall be subject to the appended claims.

1. A parallax image processing method, comprising:
obtaining at least one mask image by performing down-sampling on an initial parallax image;
performing patch processing and pixel replacement processing on the mask image to obtain a processed mask image, wherein the pixel replacement processing comprises replacing a parallax value of each pixel with a parallax value of a similar pixel corresponding to each pixel on the mask image;
determining an abnormal parallax value on the initial parallax image according to the processed mask image; and
performing interpolation processing and filtering processing on the abnormal parallax value on the initial parallax image to obtain a target parallax image.

2. The method according to claim 1, wherein performing the patch processing on the mask image comprises:
performing patch detection on the mask image to obtain the abnormal parallax value contained in a patch region on the mask image; and
setting the abnormal parallax value contained in the patch region on the mask image as a first value.

3. The method according to claim 2, wherein performing the patch detection on the mask image to obtain the abnormal parallax value contained in the patch region on the mask image comprises:
performing the patch detection on the mask image to obtain the patch region;
determining whether the patch region meets a preset condition; and
in a case where the patch region meets the preset condition, determining the parallax value of each pixel in the patch region as the abnormal parallax value contained in the patch region on the mask image.

4. The method according to claim 3, wherein the preset condition comprises a preset amount threshold and a preset mean threshold, and determining whether the patch region meets the preset condition comprises:
determining whether an amount of pixels in the patch region is less than the preset amount threshold, and whether a difference value between a parallax mean value in the patch region and the preset mean threshold is within a preset range;
in a case where the amount of the pixels in the patch region is less than the preset amount threshold, and the difference value between the parallax mean value in the patch region and the preset mean threshold is within the preset range, determining that the patch region meets the preset condition; and
in a case where the amount of the pixels in the patch region is greater than or equal to the preset amount threshold, and/or the difference value between the parallax mean value in the patch region and the preset mean threshold is not within the preset range, determining that the patch region does not meet the preset condition.

5. The method according to claim 1, wherein performing the pixel replacement processing on the mask image comprises:
determining the similar pixel corresponding to each pixel on the mask image according to an original image, wherein a difference value between a pixel value of the similar pixel and a pixel value of a corresponding pixel is a minimum value, and the original image is a gray-scale image corresponding to the initial parallax image; and
correspondingly replacing the parallax value of each pixel with the parallax value of each similar pixel.

6. The method according to claim 5, wherein determining the similar pixel corresponding to each pixel on the mask image according to the original image comprises:
finding each original pixel at a corresponding position on the original image according to a position of each pixel on the mask image;
determining a similar original pixel corresponding to each original pixel on the original image, wherein a difference value between a pixel value of the similar original pixel and a pixel value of a corresponding original pixel is a minimum value; and
according to a position of each similar original pixel, finding each pixel at a corresponding position on the mask image, and determining a found pixel as the similar pixel corresponding to each pixel on the mask image.

7. The method according to claim 6, wherein determining the similar original pixel corresponding to each original pixel on the original image comprises:
determining a search range of each original pixel on the original image by taking each original pixel as a center;
calculating pixel differences between the original pixel and other original pixels within the search range; and
determining the original pixel corresponding to a minimum pixel difference as the similar original pixel corresponding to the original pixel on the original image.

8. The method according to claim 2, wherein determining the abnormal parallax value on the initial parallax image according to the processed mask image comprises:
adjusting a resolution of the processed mask image to obtain a target mask image, wherein a resolution of the target mask image is same as a resolution of the initial parallax image; and
mapping a pixel set as the first value on the target mask image to the initial parallax image, and mapping a pixel subjected to parallax value replacement on the target mask image to the initial parallax image, so as to obtain the abnormal parallax value on the initial parallax image.

9. The method according to claim 1, wherein performing the interpolation processing on the abnormal parallax value on the initial parallax image comprises:
determining an adjacent region of a pixel corresponding to the abnormal parallax value according to a location of the pixel corresponding to the abnormal parallax value;
searching for a minimum parallax value in the adjacent region; and
replacing the abnormal parallax value with the minimum parallax value.

10. The method according to claim 1, wherein the mask image comprises a first mask image and a second mask image, a resolution of the first mask image is higher than a resolution of the second mask image, and performing the patch processing and the pixel replacement processing on the mask image to obtain the processed mask image comprises:
performing the pixel replacement processing on the first mask image to obtain a first processed mask image;
performing the patch processing on the second mask image to obtain a second processed mask image; and
determining the first processed mask image and the second processed mask image as the processed mask image.

11. The method according to claim 10, wherein obtaining the at least one mask image by performing the down-sampling on the initial parallax image comprises:
performing the down-sampling on the initial parallax image to obtain the first mask image; and
performing the down-sampling on the first mask image to obtain the second mask image.

12. The method according to claim 11, wherein performing the down-sampling on the initial parallax image to obtain the first mask image comprises:
performing Gaussian blur on the initial parallax image to obtain a processed parallax image; and
performing the down-sampling on the processed parallax image to obtain the first mask image.

13. A parallax image processing apparatus, comprising:
a first determination module, used to obtain at least one mask image by performing down-sampling on an initial parallax image;
a first processing module, used to perform patch processing and pixel replacement processing on the mask image to obtain a processed mask image, wherein the pixel replacement processing comprises replacing a parallax value of each pixel with a parallax value of a similar pixel corresponding to each pixel on the mask image;
a second determination module, used to determine an abnormal parallax value on the initial parallax image according to the processed mask image; and
a second processing module, used to perform interpolation processing and filtering processing on the abnormal parallax value on the initial parallax image to obtain a target parallax image.

14. A computer device, comprising a memory and a processor, wherein the memory stores computer programs, the processor implements steps of the method according to claim 1 when executing the computer programs.

15. A computer-readable storage medium on which computer programs are stored, wherein the computer programs, when executed by a processor, implement steps of the method according to claim 1.

16. The method according to claim 2, wherein performing the pixel replacement processing on the mask image comprises:
determining the similar pixel corresponding to each pixel on the mask image according to an original image, wherein a difference value between a pixel value of the similar pixel and a pixel value of a corresponding pixel is a minimum value, and the original image is a gray-scale image corresponding to the initial parallax image; and
correspondingly replacing the parallax value of each pixel with the parallax value of each similar pixel.

17. The method according to claim 3, wherein performing the pixel replacement processing on the mask image comprises:
determining the similar pixel corresponding to each pixel on the mask image according to an original image, wherein a difference value between a pixel value of the similar pixel and a pixel value of a corresponding pixel is a minimum value, and the original image is a gray-scale image corresponding to the initial parallax image; and
correspondingly replacing the parallax value of each pixel with the parallax value of each similar pixel.

18. The method according to claim 4, wherein performing the pixel replacement processing on the mask image comprises:
determining the similar pixel corresponding to each pixel on the mask image according to an original image, wherein a difference value between a pixel value of the similar pixel and a pixel value of a corresponding pixel is a minimum value, and the original image is a gray-scale image corresponding to the initial parallax image; and
correspondingly replacing the parallax value of each pixel with the parallax value of each similar pixel.

19. The method according to claim 3, wherein determining the abnormal parallax value on the initial parallax image according to the processed mask image comprises:
adjusting a resolution of the processed mask image to obtain a target mask image, wherein a resolution of the target mask image is same as a resolution of the initial parallax image; and
mapping a pixel set as the first value on the target mask image to the initial parallax image, and mapping a pixel subjected to parallax value replacement on the target mask image to the initial parallax image, so as to obtain the abnormal parallax value on the initial parallax image.

20. The method according to claim 4, wherein determining the abnormal parallax value on the initial parallax image according to the processed mask image comprises:
adjusting a resolution of the processed mask image to obtain a target mask image, wherein a resolution of the target mask image is same as a resolution of the initial parallax image; and
mapping a pixel set as the first value on the target mask image to the initial parallax image, and mapping a pixel subjected to parallax value replacement on the target mask image to the initial parallax image, so as to obtain the abnormal parallax value on the initial parallax image.
